(19) United States
(12) Patent Application Publication
(10) Pub. No.: US 2017/0004481 A1
(43) Pub. Date: Jan. 5, 2017

(54) SYSTEMS AND METHODS FOR RETRIEVING ELECTRONICALLY STORED INFORMATION IN REAL-TIME FOR ELECTRONIC TRANSACTIONS

(71) Applicant: Value Payment Systems, LLC, Nashville, TN (US)

(72) Inventors: Jeffrey Scott Slusser, Columbia, TN (US); Jeffrey Gardner, Nashville, TN (US)

(73) Assignee: Value Payment Systems, LLC, Nashville, TN (US)

(21) Appl. No.: 15/269,271

(22) Filed: Sep. 19, 2016

Related U.S. Application Data
(63) Continuation-in-part of application No. 13/842,802, filed on Mar. 15, 2013, now abandoned.

(51) Int. Cl. G06Q 20/22; G06Q 20/40

(52) U.S. Cl. CPC G06Q 20/227; G06Q 20/405

(57) ABSTRACT

Systems and methods for providing real-time data and performing network transactions via a GUI over a network using computer-based storage and retrieval schemes including real-time lookup tables and databases and updating the real-time lookup tables and databases in real-time, with the network including but not limited to Internet, phone, wireless communications, and other channels.

### CROSS-REFERENCE TO RELATED APPLICATIONS

This application is related to and claims priority from the following U.S. patent applications: it is a continuation-in-part of U.S. patent application Ser. No. 13/842,802, filed Mar. 15, 2013, which is incorporated herein by reference in its entirety.

### BACKGROUND OF THE INVENTION

1. Field of the Invention

The present invention relates generally to providing real-time data via a GUI over a network such as the Internet using computer-based storage and retrieval schemes including tables and databases and updating this data in real-time.

2. Description of the Prior Art

Generally, it is known in the art to conduct financial transactions using a network-based system for transmitting and receiving electronic payments. By way of example, it is known to make electronic payments over a network-based system by transactions involving payments from individuals' and business' credit, debit, prepaid, ATM card, PayPal account, Bill Me Later account, or other electronic payment methods (“Electronic Payment”) for various types of payment transactions.

While it is known in the art for a third party to charge additional fees to a credit or debit card user making an electronic payment over a network-based system, generally these fees are determined as either a flat rate fee, a percentage of the transaction or minimum charge. In any case, the prior art fee charged applies equally to any and all credit and/or debit cards. Furthermore, in the Prior Art it is often the case that the fee is provided in advance of input and/or consideration of the credit or debit card number, which confirms that the fee is applied universally to any credit and/or debit card, without regard to possible differences in interchange rates associated with specific cards.

Examples of some relevant art documents that describe credit card payment convenience fee, service fee, and the like, include the following:

U.S. Patent Application Publication Nos. 20130013441 and 20120130842 for “Transaction Services Reverse Auction” by Giordano et al., assigned to Bank of America, filed Jun. 25, 2009 and Mar. 23, 2010 respectively, published Sep. 30, 2010 and May 24, 2012 respectively, describe a transaction service provided by one of arrangement participants to another of the participants, wherein a participant may select a supplier of the service based on a value associated with the service, wherein the value may be a fee, a rate, a reward, an incentive, an opportunity, and combinations thereof. A lower fee may correspond to a higher value. The transaction fee may depend upon one or more transaction fee factors, such as interchange rate, transaction processing network rates, merchant type, merchant size, transaction processing method, and other suitable factors. After the transaction fee is identified, processor may submit the transaction fee, via merchant components, to point of sale (POS) terminal, which may display the transaction fee for viewing by the customer. The POS terminal may have one or more interactive features that the customer may use, such as information to help the consumer decide whether to execute the transaction. The customer may use the features to obtain more information about the merchant, the transaction, the transaction fee, transaction fees associated with different purchasing instruments (e.g., credit cards, debit cards, instruments or devices that include a contact chip), or combinations thereof. In some embodiments, the system may provide automatic bidding, including a bid-offer engine (software or hardware), with rules applied to apply bids to the offer, and the highest value supplier bid may be identified.

U.S. Patent Application Publication Nos. 20130013495 and 20110238596 for “Transaction Information Routing” by Giordano et al., assigned to Bank of America, filed Sep. 14, 2012 and Mar. 26, 2010 respectively, published Jan. 10, 2013 and Sep. 29, 2011 respectively, describe more than one participant of a given type may be able to participate in a transaction, wherein different participants of the same type have advantages and/or disadvantages relative to other participants of the same type. For example one issuer may be a member of a leading consortium while another is not a member, one network may require payment of a small interchange fee while another network requires payment of a large interchange fee. The customer may select a card that is associated with an issuer, and may select a signature-based transaction or a PIN-based transaction, wherein the selections may fulfill conditions necessary for application of the rule, or not.

U.S. Patent Application Publication No. 20100250379 for “Interactive Interchange Rate Decisioning” by Giordano et al., assigned to Bank of America, filed Jun. 25, 2009, published Sep. 30, 2010, describes an apparatus and methods that may enable merchants to pass along interchange costs or to provide incentives to the customer at a point of sale (POS) at which time at the POS the customer may then decide which card or payment mechanism to use, e.g., the customer may choose to use a credit card that results in the lowest transaction cost or a credit card that provides incentives, e.g., cash back, cash rewards, non-cash rewards, benefits, etc., which may be accruable. The transaction fee may be based on one or more transaction factors, such as interchange rate, network rates, merchant type, merchant size, transaction processing method.

U.S. Patent Application Publication No. 20110101091 for “Interchange Optimization for Payment Processing” by Jorge Fernandez, filed Dec. 9, 2009, published May 5, 2011, describes a method that can include determining card association for the card number and retrieving criteria for the lowest interchange rate for the card association, and prompting the merchant to provide data required by the retrieved criteria and assembling a transaction for the proposed transaction with the required data, and routing the assembled transaction to a selected payment processor. A card association for a swiped card in the card processing POS terminal can be determined and criteria requisite to a lowest exchange rate charged by the card association can be loaded, and optimization criteria pre-specified preferentially by the merchant can be loaded. The card association criteria and the optimization criteria can be mapped to the required data for a transaction and the merchant can be prompted to provide the required data through the card processing POS terminal or a computer display coupled to the card processing POS terminal. Only once the required data is provide, the processing of a transaction on the swiped card can proceed.

U.S. Pat. Nos. 8,095,438 and 8,266,057 for “Methods and systems for assigning interchange rates to financial transactions using an interchange network” by Carroll et al., assigned to MasterCard International Incorporated, filed Dec. 28, 2007 and Dec. 12, 2011 respectively, and issued Jan. 10, 2012 and Sep. 11, 2012 respectively, describe a method that includes accessing the interchange database, matching the transaction data including the identity of the issuer bank with the issuer data stored within the interchange database, and automatically assigning an interchange rate to the transaction based on the received transaction data and the issuer data stored within the interchange database. The systems and processes facilitate rewarding the card issuer for being an exclusive or priority client of the transaction card association or network. The data may also include whether particular bank identification numbers (BINs) of cards, or subsets of the cards issued by the issuer bank, have a special relationship with the bank.

U.S. Patent Application Publication No. 20120078790 for “Real-Time Interchange Fee Estimation” by Ornce et al., filed Jun. 10, 2011 and published Mar. 29, 2012, describes providing a merchant with an estimated interchange fee in real-time, which may be provided as part of an authorization or settlement processing method.

U.S. Patent Application Publication No. 20110106638 for “Cash Management Optimization for Payment Processing” by Jorge Fernandez, filed Dec. 9, 2009 and published May 5, 2011, describes a method, system and computer program product for cash management optimization method for payment processing. In an embodiment of the invention, a cash management optimization method for payment processing can include receiving a transaction profile for a proposed transaction as payment for a purchase by a purchaser from a merchant at a card processing terminal configured to identify a card number for a card. The method further can include comparing the transaction profile to merchant-specified preferences mapping different transaction profiles to different payment processors. A payment processor for the proposed transaction can be selected based upon the comparison of the transaction profile to the merchant-specified preferences.

U.S. Patent Application Publication No. 20110106695 for “Payment Processing System, Method And Computer Program Product” by Jorge Fernandez, filed Oct. 29, 2009 and published May 5, 2011, describes a method and computer program product for least cost routing in payment processing. In an embodiment of the invention, a payment processing method can include receiving a transaction profile for a proposed transaction as payment for a purchase by a purchaser from a merchant at a card processing terminal configured to identify a card number for a card. The method further can include computing a cost of processing the proposed transaction for each of multiple different payment processors based upon the received transaction profile. The method yet further can include selecting one of the different payment processors corresponding to a lowest cost of processing computed for the received transaction profile. Finally, the method can include routing the proposed transaction to the selected one of the different payment processors.

U.S. Patent Application Publication No. 20110106609 for “Electronic Couponing for Payment Processing” by Jorge Fernandez, filed Dec. 9, 2009 and published May 5, 2011, describes a method, system and computer program product for electronic couponing for payment processing. In an embodiment of the invention, an electronic couponing method for payment processing can include receiving a transaction profile for a proposed transaction as payment for a purchase by a purchaser from a merchant at a card processing terminal configured to identify a card number for a card. The method also can include presenting a coupon in the card processing terminal responsive to the transaction profile. Yet further, the method can include prompting the purchaser to redeem the coupon through the card processing terminal. Finally, the method can include reducing a payment amount for the proposed transaction if the purchaser redeems the coupon through the card processing terminal and routing the proposed transaction to a payment processor for payment processing.

U.S. Patent Application Publication No. 20120296726 for “System and Method for Managing Transactions with a Portable Computing Device” by Dessert et al., assigned to Firethorn Mobile, Inc., filed Nov. 11, 2011 and published Nov. 22, 2012, describes a method and system include verifying credentials for gaining access to a central mobile payment controller using the portable computing device (“PCD”). The central mobile payment controller may receive a merchant identifier corresponding to a merchant and then it may compare the merchant identifier against loyalty account data stored in a database. The central mobile payment controller through a tender steering module may determine if a profile of the portable computing device is associated with a merchant branded payment account and/or with a merchant branded stored value account. The central mobile payment controller may produce a message that lists one or more preferred payment options in a ranked fashion that may favor a merchant based on interchange rates.

U.S. Pat. No. 8,078,531 for “Bin Routing For Payment Processing” by Jorge Fernandez, filed Dec. 9, 2009 and issued Dec. 13, 2011, describes a method and computer program product for bank identification number (BIN) routing. In an embodiment of the invention, a BIN routing method can include receiving a transaction profile for a proposed transaction as payment for a purchase by a purchaser from a merchant at a card processing terminal configured to identify a card number for a card. A BIN can be extracted from the card number a financial institution can be determined from a list of financial institutions pre-specified to be related to the BIN. Thereafter, the proposed transaction can be routed to the determined financial institution related to the BIN.

U.S. Patent Application Publication No. 20080270275 for “Auditing or Determining Reductions to Card-Issuer Interchange Fees” by McElroy et al., assigned to PE Systems, filed Apr. 25, 2007 and published Oct. 30, 2008, describes tools capable of auditing and/or determining reductions to card-issuer interchange fees charged for credit-card transactions. The tools may do so automatically and with user interaction for thousands or even millions of transactions.

U.S. Patent Application Publication No. 20090234748 for “Interchange Fee Notification” by Skowronek et al., assigned to First Data Corp., filed Mar. 11, 2008 and published Sep. 17, 2009, describes systems and methods that alert a merchant of increased interchange fees. An increased interchange fee occurs when an electronic transaction, such as a credit card transaction, deviates from a standard set of criteria. For example, the sales person enters the credit card number rather than swipe the magnetic stripe of the credit card. In one embodiment, transaction information is provided to a merchant. The merchant sends the transaction information to an application. If the transaction is non-standard, the application can produce a notification that is sent to the merchant. The merchant may then address the causes of the increased interchange fee.

U.S. Patent Application Publication No. 20100088204 for “Method and Apparatus for Dynamic Interchange Pricing” by Nambiar et al., filed Oct. 7, 2007 and published Apr. 8, 2010, describes methods for determining and assessing dynamic interchange fees based on payment card account spending history using a spending history database.

U.S. Patent Application Publication No. 20110302080 for “Method and Apparatus for Value Interchange Pricing” by White et al., filed Jun. 3, 2011 and published Dec. 8, 2011, describes a method including the step of establishing dynamic interchange pricing based on a payment account's relative or actual value.

U.S. Pat. No. 8,019,680 for “Altering Card-Issuer Interchange Categories” by McElroy et al., assigned to PE Systems, LLC, filed Oct. 12, 2009 and issued Sep. 13, 2011, describes tools capable of determining ways in which to alter interchange categories assigned to credit-card transactions. In some embodiments, the tools receive parameters for interchange categories and transaction information for a client (e.g., one or more merchants) that has been charged interchange fees based on some of these categories. The tools may determine, based on these parameters and transaction information, how parameters may be changed to enable similar credit-card transactions to be assigned a lower-cost interchange category and the accompanying potential fee savings.

U.S. Pat. No. 8,019,681 for “Interchange Categories” by McElroy et al., assigned to PE Systems, LLC, filed Dec. 31, 2009 and issued Sep. 13, 2011, describes tools capable of altering to which interchange categories credit-card transactions are assigned. In some embodiments, the tools receive parameters for interchange categories and transaction information for a client (e.g., one or more merchants) that has been charged interchange fees based on some of these categories. The parameters are utilized (e.g., by a credit card issuer) to determine to which interchange category a particular transaction will be assigned. The tools may determine, based on these parameters and the transaction information, how transactions may be changed to enable similar credit-card transactions to be assigned to a lower-cost interchange category.

U.S. Pat. No. 8,024,268 for “Altering Card-Issuer Interchange Categories” by McElroy et al., assigned to PE Systems, LLC, filed Sep. 4, 2009 and issued Sep. 20, 2011, describes tools capable of determining ways in which to alter interchange categories assigned to credit-card transactions. In some embodiments, the tools receive parameters for interchange categories and transaction information for merchants that have been charged interchange fees based on some of these categories. The tools may determine, based on these parameters and transaction information, how parameters may be changed to enable similar credit-card transactions to be assigned a lower-cost interchange category and the accompanying potential fee savings.

U.S. Pat. No. 8,244,634 for “Interchange Categories” by McElroy et al., assigned to PE Systems, LLC, filed Sep. 19, 2011 and issued Aug. 14, 2012, describes tools capable of altering to which interchange categories credit-card transactions are assigned. In some embodiments, the tools receive parameters for interchange categories and transaction information for a client (e.g., one or more merchants) that has been charged interchange fees based on some of these categories. The parameters are utilized (e.g., by a credit card issuer) to determine to which interchange category a particular transaction will be assigned. The tools may determine, based on these parameters and the transaction information, how transactions may be changed to enable similar credit-card transactions to be assigned to a lower-cost interchange category.

U.S. Pat. No. 7,603,312 for “Altering Card-Issuer Interchange Categories” by McElroy et al., assigned to PE Systems, filed Apr. 25, 2007 and issued Oct. 13, 2009, describes tools capable of determining ways in which to alter interchange categories assigned to credit-card transactions and the accompanying potential fee savings. In some embodiments, the tools receive parameters for interchange categories and transaction information for merchants that have been charged interchange fees based on some of these categories. The tools may determine, based on these parameters and transaction information, parameter changes that enable similar credit-card transactions to be assigned a lower-cost interchange category and the accompanying potential fee savings.

U.S. Pat. No. 8,301,559 for “Determination of Interchange Categories” by McElroy et al., assigned to PE Systems, LLC, filed Nov. 30, 2011 and issued Oct. 30, 2012, describes tools capable of auditing and/or determining reductions to card-issuer interchange fees charged for credit-card transactions. The tools may do so automatically and with user interaction for large amounts of transactions.

U.S. Pat. No. 7,873,540 for “Virtual Terminal Payer Authorization Systems and Methods” by Avin Arumugam, assigned to First Data Corp., filed Sep. 20, 2006 and issued Jan. 18, 2011, describes a method of obtaining payer authorization for a purchase instrument transaction with a customer includes using a wireless device of a merchant to contact a virtual terminal service to process the transaction, entering transaction information into the wireless device, which transaction information includes an account identifier relating to the purchase instrument of the customer, forwarding the transaction information from the wireless device to the virtual terminal service, receiving at the wireless device a request from the virtual terminal service to receive payer authorization information from the customer, receiving the payer authorization directly from the customer into the wireless device of the merchant, forwarding the payer authorization from the wireless device to the virtual terminal service, and receiving an approval message from the virtual terminal service at the wireless device of the merchant.

### SUMMARY OF THE INVENTION

The present invention is directed to methods for processing payments electronically over a transaction processing network (a “network-based system”), such as Internet, phone, wireless communications and other channels, wherein a third party or intermediary facilitates payment transactions to enable the processing of transactions on behalf of individuals through credit and debit card electronic transactions while providing a real-time, automated determination of the convenience fees associated with the transaction, the fee based, at least partly, upon interchange rate for the specific card being used for the payment.

One embodiment of the present invention provides a method for processing transactions electronically over a network-based system including the steps of: providing a system for conducting transactions directly to any entity for receiving and remitting payments from individuals or businesses; initiating a transaction for making a payment on behalf of an individual cardholder; receiving electronic payment information or data and corresponding to a cardholder account, specifically a unique number for a card; automatically making a real-time lookup for an interchange rate associated with the card; automatically transforming the interchange rate into a convenience fee by combining all factors associated with any fees for the specific transaction with the real-time lookup of the interchange rate; presenting the information of the convenience fee to the cardholder for approval.

Significantly, the convenience fee is generated, at least partly, from the individual real-time interchange rate for the specific card number provided by the cardholder, which number is often received by the system in advance of making the lookup for that interchange rate. Thus, the interchange rate included in the convenience fee is card-specific, and the convenience fee determined is also based upon the information associated with the card number provided.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a flow diagram illustrating one embodiment of steps involved in a card transaction over a network-based system.

FIG. 2 is a schematic diagram of a computer network and remote access occurring over a network-based system.

FIG. 3 is a flow diagram representing one embodiment of the entities exchanging information during a card transaction.

FIG. 4 is a schematic diagram of one embodiment of the information exchange occurring during a convenience fee calculation.

FIG. 5 is a screenshot of one embodiment of a GUI including a service description.

FIG. 6 is a screenshot of one embodiment of a GUI including a comparison tool.

FIG. 7 is a screenshot of one embodiment of a GUI including a comparison tool with card entry.

FIG. 8 is a screenshot of one embodiment of a GUI including results from interchange look-up.

FIG. 9 is a screenshot of one embodiment of a GUI including a result of consumer driven options/savings.

FIG. 10 is a screenshot of one embodiment of a GUI including expedited card entry.

FIG. 11 is a screenshot of one embodiment of a GUI including a summary of account information, payment information, and terms and conditions.

FIG. 12 is a screenshot of one embodiment of a GUI including a Convenience Fee Comparison Service.

FIG. 13 is a screenshot of one embodiment of a GUI including a Convenience Fee Comparison Service.

FIG. 14 is a screenshot of one embodiment of a GUI including a Convenience Fee Comparison Service.

FIG. 15 is a screenshot of one embodiment of a GUI including a Convenience Fee Comparison Service.

FIG. 16 is a screenshot of one embodiment of a GUI including a Convenience Fee Comparison Service in which one of the radio buttons is selected and details of the convenience fee are provided for MasterCard, CapitalOne.

FIG. 17 is a screenshot of one embodiment of a GUI including a Convenience Fee Comparison Service including selection of a radio button next to the Special Offer.

FIG. 18 is a screenshot of one embodiment of a GUI including a Convenience Fee Comparison Service in which one of the radio buttons is selected and details of the convenience fee are provided for VISA, Citibank.

FIG. 19 is a screenshot of one embodiment of a GUI including a Convenience Fee Comparison Service including a pop-up with information about an interchange fee for VISA, Citibank.

FIG. 20 is a screenshot of one embodiment of a GUI including a Convenience Fee Comparison Service including a pop-up with details about an interchange fee.

FIG. 21 is a screenshot of one embodiment of a GUI including a Convenience Fee Comparison Service including a pop-up with information about an Assessments Fee.

FIG. 22 is a screenshot of one embodiment of a GUI including a Convenience Fee Comparison Service including a pop-up with details about an Assessments Fee.

FIG. 23 is a screenshot of one embodiment of a GUI including a Convenience Fee Comparison Service including a pop-up with information about the VPS fee.

FIG. 24 is a screenshot of one embodiment of a GUI including a Convenience Fee Comparison Service including a pop-up with details about the VPS fee.

FIG. 25 is a screenshot of one embodiment of a GUI including a Payment Information section including information about the payment information selected.

FIG. 26 is a screenshot of one embodiment of a GUI including a confirmation number and confirmation details.

### DETAILED DESCRIPTION

The following definitions are provided to indicate usage of the terms in this document:

Acquirer means a financial institution that contracts with Merchants to enable card transactions or disburse currency to a Cardholder, and directly or indirectly enters the resulting Transaction receipt into the Interchange.

BIN means a number, usually 6 digits, assigned by a Card Association and used to identify a Card Association member or Processor for authorization, clearing, settlement processing, or similar processes or services.

Card means all credit, debit, ATM, and prepaid cards

Card Association means MasterCard International, Visa U.S.A. or Visa International, or any other entity that are licensing regulatory agencies for bankcard activities.

Cardholder means an individual who is issued and authorized to use a Card or has a virtual account that functions similar to a Card when making electronic payments.

Convenience Fee means a charge to the Cardholder in addition to the original transaction amount; calculations of such are based on, by way of example and not limitation, factors such as Dues and Assessments, Interchange Fees, Service Provider Fees, and/or any other fees additional to the original transaction amount; also referred to as a Service Fee or Surcharge.

Dues and Assessments means the processing fees paid to the Card Associations to finance their roles in operating the network, setting rules, setting pricing, research and development, and marketing and branding; calculated both as a set percentage of the sale and a fixed dollar amount and are generally collected on a daily and/or monthly basis.

Interchange means the standardized electronic exchange of financial and non-financial data associated with sale and credit data between Merchant, Acquirers, Card Associations, and other entities on various types of transactions.

Interchange Fee means a fixed amount per Transaction and/or percentage applied, according to Card Association regulations, to the dollar value of each Transaction.

Interchange Rate means a fee paid by an Acquirer to an issuing bank for transactions entered into the Interchange; Card Associations each have their own criteria for their own fee categories, each fee category having its own applicable Interchange Rate; specific criteria is evaluated for each Transaction to determine the applicable Interchange Fee; also called Interchange Reimbursement Fee (IRF); e.g., if the Interchange Rate is 1.43%+USD 0.05, and the Transaction amount is USD 100, then the calculated Interchange Fee=(USD 100×1.43%)+USD 0.05=USD 1.48.

Merchant means an entity that contracts with an Acquirer, Processor and/or a Service Provider to originate Transactions.

Network-based System means any transaction processing network, such as Internet, phone, wireless communications, and other channels.

Payment Channel means the delivery method by which Transactions are sent to a Processor; e.g., the Internet, Interactive Voice Response (IVR) phone service, Automated Clearing House (ACH), and lockbox.

Payment Gateway means a service or system for transmitting and receiving transaction information from a web site, Interactive Voice Response system, point-of-sale device, or other network-based systems to a Processor or Acquirer.

Payment Method means the means of payment employed by a purchaser, such as cash, check, money order, or Card.

Processor means an entity that routes transaction information to a Card Association or Network-based System.

Service Provider means an entity that contracts with an Acquirer and/or Processor and/or Merchant to provide payment services to a Merchant.

Service Provider Fee means the fee(s) charged by a Service Provider, Acquirer, Processor, Merchant or other entity that is assessing the Convenience Fee(s).

Surcharge means a fee that a Merchant or Service Provider adds to the cost of a purchase when a customer uses a Card.

Transaction means any action between a Cardholder and a Merchant, Service Provider, Acquirer, Processor or other entity that results in activity on the Card account, such as a purchase, payment, cash advance or credit.

Referring now to the drawings in general, the illustrations are for the purpose of describing a preferred embodiment of the invention and are not intended to limit the invention thereto. The present invention provides methods of electronically processing transactions over a network-based system, preferably the Internet, phone, or any other communications network, including real-time lookup of an interchange rate associated with a specific card for conducting the transaction, and transforming the interchange rate into a convenience fee, including transparent indication of factors in generating the convenience fee, and providing selection options for the cardholder to approve or decline the total fee presented, either alone or in comparison to alternatives having a lower total fee, including lower interchange rate based on real-time lookup for cards associated with different issuing banks, networks, and combinations thereof.

None of the prior art references identified hereinabove teach or describe all of the elements of the present invention, and none address the longstanding unmet need in the art to provide more transparency and flexibility to the processes associated with additional transaction fees (“convenience fees”) associated with credit or debit cards for electronic network-based transactions. Thus there remains a need for the solutions provided by the present invention as described herein.

Since the prior art set forth in the foregoing does not provide the solutions that continue to exist as a longstanding and unmet need, there remains a need for processing transactions electronically over a network-based system, with a real-time lookup of an interchange rate associated with the card or BIN number provided by the cardholder for making the electronic transaction, and for providing a transparent indication of itemized factors included in a convenience fee, which includes the real-time lookup of the interchange rate for that specific card and corresponding specific transaction.

Convenience fees are currently either charged to the cardholder as a separate transaction or combined with the original transaction amount that is settled to the merchant. The prior art for assessing convenience fees does not calculate the convenience fee on an individual transaction basis based on the actual fees and factors associated with the card, such as the individual cardholder's interchange rate. Therefore, since the convenience fees charged to the cardholder are not based on the actual card used on an individual transaction basis, cardholders paying a given merchant, are charged the same convenience fee based on the merchant, payment method, payment channel, the service provider, merchant or acquirer's underlying aggregate cost structure and/or if the cardholder is using a credit, debit, or prepaid card. This creates an issue where a cardholder paying a merchant may be using a card that has lower real-time convenience fee than another Cardholder's Card, however the convenience fee assessed to both cardholders is the same.

Prior Art Example 1 involves Cardholder 1 making a $500.00 citation payment with a merchant using a “Visa Signature Preferred CPS/Card Not Present” Interchange Reimbursement Fee Card and Cardholder 2 making a $500.00 citation payment to a merchant using a “Visa CPS/Retail 2” Interchange Reimbursement Fee Card. The underlying Interchange Rate cost of the Visa Signature Preferred CPS/Card Not Present Interchange Reimbursement Fee Card is $12.10 and the underlying interchange rate cost of the Visa CPS/Retail 2 Interchange Reimbursement Fee Card $7.20. In this example the convenience fee charged to both Cardholder 1 and Cardholder 2 is 2.50% based on the $500.00 citation transaction amount or $12.50. The convenience fee is the same for Cardholder 1 and Cardholder 2 even though the underlying interchange rate cost of Cardholder 1 transaction is $12.10 and the underlying interchange rate cost of Cardholder 2 transaction is $7.20. This problem leads to lower interchange rate cost card transactions subsidizing the cost of higher cost cards when the convenience fee is the same for both of the aforementioned cardholders.

Prior Art Example 2 involves Cardholder 1 making a $1000.00 tax transaction using a “MasterCard Consumer Debit Emerging Markets” Interchange Rate Card and Cardholder 2 making a $1000.00 tax transaction using a “MasterCard Regulated POS Debit” Interchange Rate Card. The underlying interchange rate cost of the MasterCard Consumer Debit Emerging Markets Interchange Rate Card is $8.53 and the underlying interchange rate cost of the MasterCard Regulated POS Debit Interchange Rate Card is $0.92. The convenience fee charged to both Cardholder 1 and Cardholder 2 is $3.95 regardless of the transaction amount. The convenience fee is the same for Cardholder 1 and Cardholder 2 even though the underlying interchange rate cost of Cardholder 1 transaction is $8.53 and the underlying interchange rate cost of Cardholder 2 transaction is $0.92. This problem leads to lower interchange rate cost cards to subsidize the cost of higher cost cards when the convenience fee is the same for both of the aforementioned cardholders.

By contrast to the prior art, the present invention provides real-time interchange rate lookup based upon the received card number information at the time it is received. The present invention calculates the convenience fee for each individual transaction based on the actual card interchange rate associated with card that is being used to pay the merchant.

Under the present invention the convenience fee is determined for each individual transaction that is made to a given merchant by preforming a BIN file lookup, or other real-time interchange rate lookup method, in real-time upon receipt of the card number information to determine the actual interchange rate associated with the card that is being used to pay the merchant. The interchange rate cost is then combined with dues and assessments, surcharges, service provider fee(s), and other fees and factors to determine the convenience fee that is charged to the cardholder.

Furthermore, the present invention provides the ability to charge the same consistent service provider fee(s) to all transactions for a given merchant regardless of the interchange rate. Therefore, the convenience fee charged to each cardholder is operable to vary based on the card that is used to process a transaction.

In one embodiment of the present invention, the “mark-up” above the actual interchange rate or the additional fees included in the generation of the convenience fee is consistent for a given merchant. By way of example and not limitation, for the purpose of illustrating the present invention, in such a case the convenience fee is equal to the mark-up of 0.20%+$0.20 above the actual interchange rate for a given transaction for a given merchant.

Present Invention Example 1 involves Cardholder 1 making a $500.00 citation payment using a “Visa Signature Preferred CPS/Card Not Present” Interchange Reimbursement Fee Card with a 0.20% service provider fee(s) and Cardholder 2 making a $500.00 citation payment using a “Visa CPS/Retail 2” Interchange Reimbursement Fee Card with a 0.20% service provider fee(s). The underlying interchange rate cost of the Visa Signature Preferred CPS/Card Not Present Interchange Reimbursement Fee Card is $12.10 and the underlying interchange rate cost of the Visa CPS/Retail 2 Interchange Reimbursement Fee Card $7.20. According to the present invention, the convenience fee charged to Cardholder 1 is $13.10 and the convenience fee charged to Cardholder 2 is $8.20. Furthermore, the present invention eliminates the issue of having lower interchange rate cost card transactions subsidizing the cost of higher cost cards when the convenience fee is the same for both of the aforementioned cardholders.

Present Invention Example 2 involves Cardholder 1 making a $1000.00 tax transaction using a “MasterCard Consumer Debit Emerging Markets” Interchange Rate Card with a 0.20% service provider fee(s) and Cardholder 2 making a $1000.00 tax transaction using a “MasterCard Regulated POS Debit” Interchange Rate Card with a 0.20% service provider fee(s). The underlying interchange rate cost of the MasterCard Consumer Debit Emerging Markets Interchange Rate Card is $8.53 and the underlying interchange rate cost of the MasterCard Regulated POS Debit Interchange Rate Card $0.92. Under the present invention, the convenience fee charged to Cardholder 1 is $10.53 and the convenience fee charged to Cardholder 2 is $2.92. Furthermore the present invention eliminates the issue of having lower interchange rate cost card transactions subsidizing the cost of higher cost cards when the convenience fee is the same for both of the aforementioned cardholders.

In one embodiment, the present invention provides a method for processing transactions electronically over a network-based system including the steps of: providing a system or device for conducting transaction directly with any entity for receiving and remitting transaction amounts from individuals; initiating a transaction on behalf of an individual cardholder or a business cardholder; receiving transaction information or data and corresponding to a cardholder account, specifically a unique number for a credit card or a debit card; automatically making a real-time lookup for an interchange rate associated with the credit card or debit card; automatically transforming the interchange rate into a convenience fee by combining all factors associated with any fees for the specific transaction with the lookup of the interchange rate; and presenting the information of the convenience fee to the cardholder for approval.

In another embodiment of the present invention, the system or device is operable to transparently provide itemized information for each factor used to determine the convenience fee. Preferably, the itemized information includes at least one of the following fees: interchange fee, dues and assessments, service provider fee(s), and combinations thereof. Additional steps include receiving approval of the cardholder for the convenience fee presented, or receiving decline of approval by the cardholder. If a decline of approval is received, then the cardholder repeats the above steps for a second card, including the unique number associated with the second card. This is repeated N times until the cardholder approves the convenience fee presented. Additionally, or alternatively, the method of the present invention includes a step of presenting a multiplicity of card issuers and associated lower interchange rates and/or convenience fees compared with the interchange rate and/or convenience fee of the first card information provided by the cardholder. In this case, the cardholder has the option of providing an alternate card number, and the above steps are repeated N times until the cardholder approves the convenience fee presented. In one embodiment, multiple card numbers are entered for transmitting and for receipt and lookup automatically by the system, wherein multiple convenience fees are generated and provided, which correspond to each of the multiple cards.

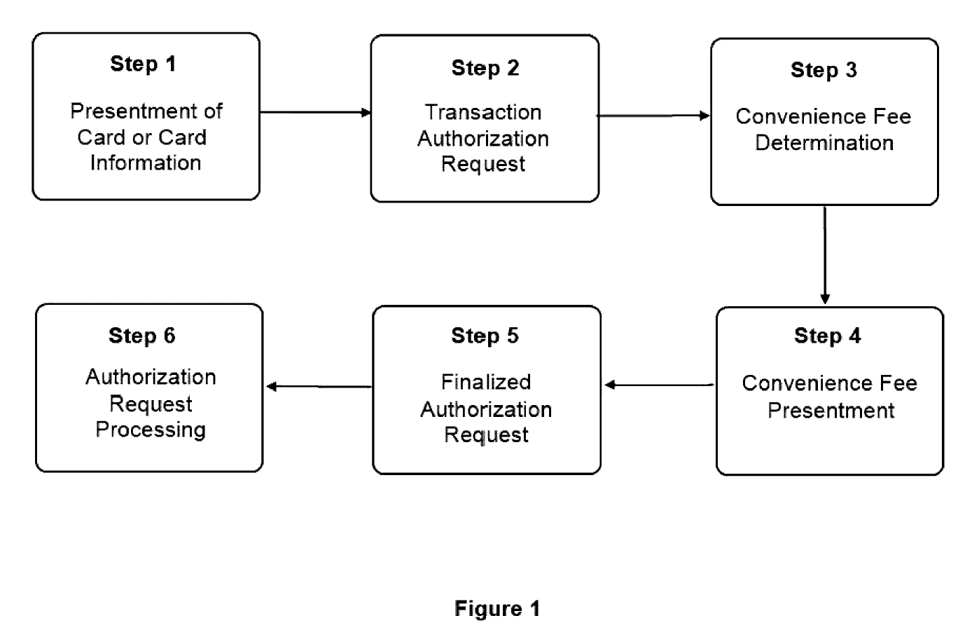

More specifically, as illustrated by the flow diagram of FIG. 1 the present invention additionally provides a method for making electronic financial transactions with merchants, service providers, creditors, or any transaction amount recipient including the steps of: providing a network for making electronic data communications, including secure transmission of transaction data for transmitting electronic transactions between a cardholder and a transaction amount recipient, over a network-based system; initiating a transaction over the network, optionally via a web-based interactive user interface, or making the electronic payment; receiving cardholder information, including card type (credit or debit), card number, expiration date, cardholder name, etc., with at least the card number data being provided; automatically making a real-time bank identification number (BIN) lookup, or other real-time interchange rate lookup method, to determine the actual real-time interchange rate for that specific card number provided; automatically transforming the interchange rate into a convenience fee rate for processing that specific card for the amount associated with the specific transaction entered; receiving authorization and data for use of the specific card with the specific convenience fee; receiving authorization and data approving the electronic transaction. Other method steps according to the present invention include automatically indicating alternative forms of payment including credit card issuing banks having lower interchange rates for the specific transaction; prompting the cardholder to confirm the transaction, or to enter another card number. In one embodiment, these steps are repeated until receiving input that the cardholder approves the convenience fee.

In one embodiment, indicating alternative forms of payment includes alternative forms of payment such as electronic accounts including electronic wallets or cryptocurrencies, decentralized digital currencies, or electronic currencies including Bitcoin, Ven, and/or Utoken. In another embodiment, the systems and methods of the present invention include issuing the alternative account, including electronic accounts, credit card accounts, debit card accounts, prepaid accounts, etc. to the user.

Notably, the present invention is inextricably tied to computer technology because systems and methods of the present invention utilizes devices connected over a network to determine in real-time convenience fees associated with electronic credit card-based transactions, debit card-based transactions, or transactions using any electronic accounts such as electronic wallets or cryptocurrencies, decentralized digital currencies, or electronic currencies including Bitcoin, Ven, and/or Utoken. Electronic credit card-based transactions, debit card-based transactions, or transactions using any electronic accounts could not have been performed before the Internet. Furthermore, these transactions are not merely taking a concept known from the pre-Internet world or the pre-computer world with the requirement to perform the transactions over the Internet or over a computer network. Rather, these transactions require technology specific to the Internet or computer networks, and could not be performed in a pre-Internet or pre-computer technology world.

In one embodiment of the present invention, lookups are performed via a set of application programming interfaces (APIs) that gives customers and clients the means to integrate with a look up to the card details. The APIs and lookups support Simple Object Access Protocol (SOAP) protocols and Representational State Transfer (REST) protocols. Data is exchanged in the form of Extensible Markup Language (XML), JavaScript Object Notation (JSON), or Name-value pair (NVP).

In one embodiment, the BIN lookup or other real-time interchange rate lookup is performed in real-time using self-referential convenience fee tables. In another embodiment, the BIN lookup or other real-time interchange rate lookup is performed via a data storage and retrieval system for a computer memory over a network in real-time, wherein the system uses a logical table including a plurality of logical rows and plurality of logical columns to look up, store, and present real-time data. The plurality of logical columns intersects the plurality of logical rows to define a plurality of logical cells. Each logical row corresponds to a record of information, preferably a convenience fee or components of a convenience fee, including an interchange fee, an assessment fee, and/or a service provider fee. Alternatively, each logical column corresponds to a record of information, preferably a convenience fee or components of a convenience fee, including an interchange fee, an assessment fee, and/or a service provider fee. In one embodiment, the logical column or logical row includes one or more formulas for determining any of the aforementioned fees. Object identification numbers (OD) are used in one embodiment to identify each logical row and/or each logical column.

In one embodiment, the system maintains a profile database including fee tables and other computer-based storage schemes for fee data storage. The fee tables and other computer-based storage schemes utilize a logical table including a plurality of logical rows and plurality of logical columns to look up, store, and present real-time data in one embodiment. The Interchange Rate Based Convenience Fee, Service Fee, and Surcharge System is operable to add, modify and delete fee tables in the logical table format, the logical table format including a plurality of logical rows and plurality of logical columns to look up, store, and present real-time data whenever new fee data is received from the Fee Creation Entities over the external network.

In one embodiment, the BIN lookup or other real-time interchange rate lookup is performed via a data storage and retrieval system for a computer memory, including means for configuring said memory according to a logical table, said logical table including: a plurality of logical rows, each said logical row including an object identification number (OD) to identify each said logical row, each said logical row corresponding to a record of information, a plurality of logical columns intersecting said plurality of logical rows to define a plurality of logical cells, each said logical column including an OID to identify each said logical column, and means for indexing data stored in said table.

Means for configuring the memory include, but are not limited to, creating in a computer memory, a logical table that need not be stored contiguously in the computer memory, the logical table being comprised of rows and columns, the rows corresponding to records, the columns corresponding to fields or attributes, the logical table being capable of storing different kinds of records; assigning each row and column an object identification number (OD) that, when stored as data, acts as a pointer to the associated row or column and that is operable to be of variable length between databases; and for each column, storing information about that column in one or more rows, rendering the table self-referential, the appending, to the logical table, of new columns that are available for immediate use being possible through the creation of new column definition records; and in one or more cells defined by the intersection of the rows and columns, storing and accessing data, which includes structured data, unstructured data, or a pointer to another row.

Means for indexing includes, but is not limited to, extracting key numbers or percentages from the applicable cells in the logical table; storing the extracted key numbers or percentages in an index, which is itself stored in the logical table; including, in cells of the logical table, pointers to the corresponding entries in the index, and including, in the index, pointers to the text cells.

In one embodiment of the present invention, the step of automatically indicating alternative credit card and/or debit card issuing banks having lower interchange rates for the specific transaction further includes presenting information via the web-based graphical user interface “GUI” (or other interface) showing a comparison of a multiplicity of alternative card types and/or issuing banks that provide lower interchange rates, and where applicable lower convenience fees, for the specific transaction. Also, the interchange rates associated with each of those cards is displayed. In another embodiment, other steps are included for prompting the cardholder to input multiple card numbers from different cards into separate fields in a web-based GUI (or other interface); with a subsequent step of the system automatically generating a new convenience fee for each card number inputted by the cardholder and received by the server associated with the system. Preferably, for multiple card number entries, the cardholder is presented and provides an input to select the desired card number and associated convenience fee, approve the transaction, submit electronically and complete the transaction.

Another step optionally includes ranking the presented information in order of lowest total fees to highest total fees. Additionally, a step of prompting the cardholder to select one of the presented options is provided. Where the cardholder provides inputs that are received, then a subsequent step of automatically generating a new total fee is provided, wherein the new total fee is determined based upon the credit card information provided and received as inputs from the cardholder. Preferably, these steps are repeated until the transaction is approved by the cardholder, submitted electronically, and completed.

Another embodiment or method step of the present invention provides the cardholder with at least one of the factors or fees used in the calculation of the convenience fee. Providing this information to the cardholder educates the cardholder as to the options available and to the underlying factors and fees that determine the convenience fee. Other optional method steps and embodiments of the system according to the present invention include providing the cardholder the option of acquiring a new cardholder account is provided, which would permit the cardholder to obtain a lower convenience fee on the present or future transaction. Furthermore, this optional method step and embodiment includes the capability to issue a credit or debit card, for immediate use. Other optional method steps according to the present invention include automatically indicating alternative credit card and/or debit card options having lower interchange rates, and associated convenience fees, for the specific transaction and the capability to issue a credit or debit card, for immediate use, that was provided as an alternative credit card and/or debit card options having lower interchange rates, and associated convenience fees, for the specific transaction. The aforementioned capability provides the cardholder with the benefit of providing access to lower cost convenience fee alternatives.

Optionally, an additional step of receiving a digital or physical confirmation of the transaction is included. Alternatively and also optionally, an additional step of receiving notice of a declined transaction is provided.

FIG. 1 displays the steps involved in a card transaction over a network-based system. In step one a cardholder presents a card to pay for goods or services. For card-not-present transactions, the cardholder provides the merchant with the account number, expiration date, and/or other transaction information through the Internet, phone or other payment channel. By way of example and not limitation, the other transaction information includes a billing address or security code. Alternatively, if the transaction is a card present transaction, the merchant or cardholder swipes the card through a magnetic-card reader, dips the card into a chip-reading device, or waives the card in front of a NFC reader. In another embodiment, radio frequency (RF) technology is used, including RFID technology. In another embodiment, the transaction is a transaction performed via a mobile wallet, such as ApplePay or Google Wallet. Notably, NFC readers and RF readers are not generic computing devices as these readers require specialized hardware for reading transaction instruments.

In step 2, the merchant enters the transaction amount, and, if necessary, transmits an authorization request to the acquirer. For card not present transactions, the cardholder or service provider enters the amount, account number, and other information is operable to be digitally or key-entered.

Steps 1 and 2 are generally known in the prior art. By contrast to the present invention, an entity of the prior art executes step 3, determination of the convenience fee, by applying a uniformly flat fee or fixed percentage or uniform combination of both based on a service provider's, merchant's or processor's underlying aggregate cost structure and/or the type of card used, the merchant, and the payment channel. Distinguishably, the present invention further considers the interchange rate for the individualized cardholder account. Furthermore, the present invention determines the convenience fee individually and does not simply calculate the convenience fee uniformly.

In step 4, the convenience fee and other transaction information is presented to the cardholder for approval. In the prior art, the convenience fee alone was presented. In the present invention, the convenience fee and optionally the fees and factors used in calculating the convenience fee, is displayed to the cardholder for approval. Then, in step 5, if the cardholder accepts the convenience fee, the merchant or service provider transmits an authorization request to the acquirer. The acquirer sends the authorization request to an association or payment network, and, in step 6, the transaction process continues according to commercial steps, which are known and appreciated to one of ordinary skill in the art.

The present invention provides a method of completing electronic transactions from individuals' and business' cards, other electronic transaction methods, or combinations thereof, hereinafter defined and referred to as individually and collectively as electronic transactions.

Additionally, the present invention provides methods that facilitate electronic transactions to be made over the network-based system to the any transaction amount recipient, including but not limited to merchants, service providers, government agencies, creditors, banks, and online businesses. Also, the present invention includes all communications channels for making electronic transactions, including but not limited to communications via Internet-based computer, phone, smart phone, mobile device, mobile wallet, point of sale terminals, and combinations thereof.

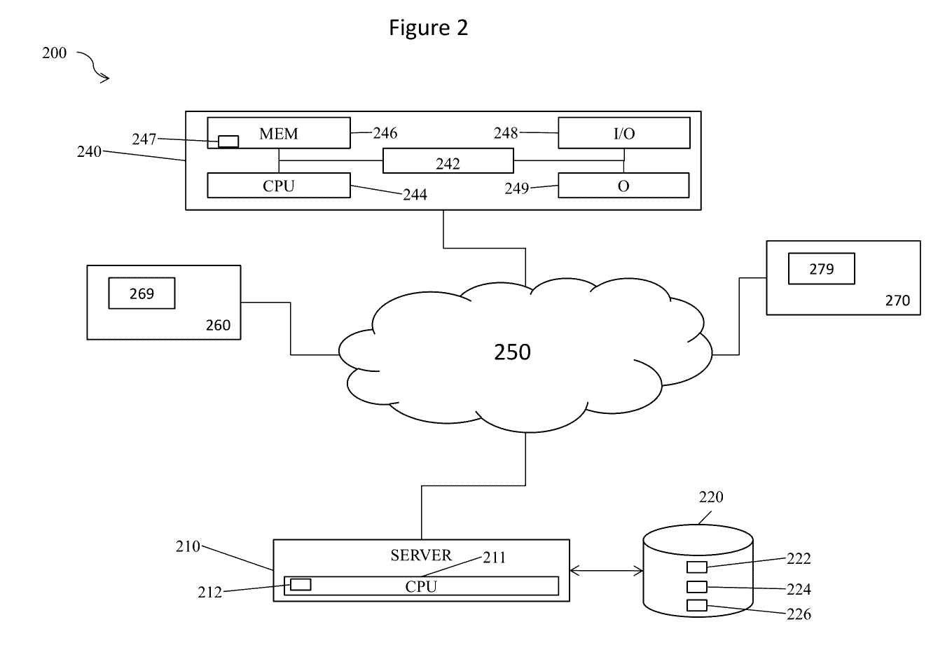

As illustrated in FIG. 2, the system 200 comprises a server 210 with a processing unit 211. The server 210 is constructed, configured and coupled to enable communication over a network 250. The server provides for user interconnection with the server over the network using a personal computer (PC) 240 positioned remotely from the server. Furthermore, the system is operable for a multiplicity of remote personal computers or terminals 260, 270 to access the server remotely. For example, in a client/server architecture or alternatively, and preferably, a user interconnects through the network 250 using a user device such as a mobile communication device, such as by way of example and not limitation, a mobile phone, a cell phone, smart phone, laptop computer, netbook, a terminal, personal digital assistant (PDA), or any other computing device suitable for network connection. Also, alternative architectures are used in other embodiments instead of the client/server architecture. For example, in another embodiment, a PC network, or other suitable architecture is used. In preferred embodiments, the network 250 is the Internet, or it could be an intranet, or any other network suitable for searching, obtaining, and/or using information and/or communications, including receiving the notification and providing a response.

The system of the present invention further includes an operating system 212 installed and running on the server 210, enabling server 210 to communicate through network 250 with the remote, distributed user devices. The operating system is selected from any operating system known in the art that is suitable for network communication.

A memory 220 is interconnected with the server 210. Memory 220 is integral with server 210 or external to the server and interconnected therewith. A program of instruction 222 is stored on memory 220. According to an exemplary embodiment, the program 222 is computer executable code for using information derived from electronic transactions made over the network, and more particularly for real-time interchange rate determination associated with received data for a credit card or debit card number provided as inputs by the cardholder user of the system. In preferred embodiments, the system is cloud computing based, with the remote client or customer computer devices merely accessing the system, inputting, sending, and receiving notification via the web, the Internet, or other network.

In one embodiment, a remote user (cardholder or account holder) connects to the server 210 through network 250 from a computing device 240. According to an exemplary embodiment, computing device 240 is a personal computer or smartphone device that is constructed and configured for network communication and data transfer. In one embodiment, computing device 240 comprises a bus 242 interconnected to the network 250 such as through a modem, an Ethernet card, or any wired or wireless network communications components. A processing unit 244 is operable to be interconnected with the bus 242. A memory 246 is operable to be interconnected with the processing unit 244 through bus 242. The computing device 240 also comprises one or more input/output devices 248, such as a mouse, a keyboard, a printer, and the like interconnected to the processing unit 244 through bus 242. A display 249, 269, 279 is operable to be interconnected with the processing unit 244 through bus 242 for providing a graphical user interface on a display, corresponding to a website, preferably interactive GUI and website.

Computing device 240 is operable to include a program of instruction 247, such as a driver enabling computing device 240 to interconnect with server 210 through network 250.

When the cardholder user enters inputs information into the memory 220, the server 210 creates and updates a profile database 222. The server then executes a matching program 224 against the data stored in memory 220 to match the credit card or debit card number with the corresponding interchange rate at the time of the inquiry and before the electronic online transaction is processed, which includes any data relating to the system for all time or predetermined time. The first 6-8 digits of the card number are used to automatically conduct the real-time lookup of the interchange rate for the BIN file, which includes the following factors: issuing bank, credit or debit card type, business or individual card, and combinations thereof. The program 224 detects attributes of the data, in particular interchange rates associated with the credit or debit card number received by the system, and transforms those attributes into a transparent convenience fee by combining the specific interchange rate with other fees associated with the credit or debit card. Notably, the convenience fee is not a flat fee or a flat percentage rate fee, i.e., the transparent convenience fee includes the specific interchange rate that is determined and displayed on a graphic user interface (GUI) on a display viewable by the cardholder user. Significantly, the transformation of the interchange rate specific to the card number provided, into the transparent convenience fee includes transaction level determination, i.e., only the actual fees associated with the specific card for electronic transaction are included. Preferably, messaging is automatically generated to provide the transparent convenience fee information to the cardholder user.

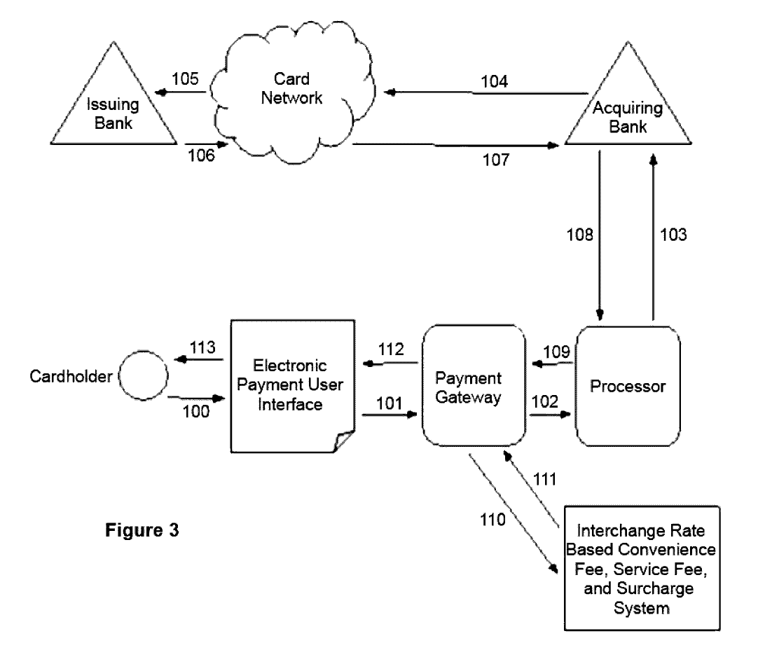

As illustrated in FIG. 3, a remote user (cardholder) connects to the Electronic Payment User Interface [100] from a computing device, or directly if the Electronic Payment User Interface is on a Point-of-Sale or Virtual Terminal device at a merchant location. Via the Electronic Payment User Interface, the cardholder begins a payment transaction and enters the card data. The Payment Gateway receives the cardholder data for the associated transaction [101] and sends the data to the electronic payment Processor [102]. The Processor follows the existing payment authorization processes be transmitting the cardholder data to the Acquiring Bank [103], which uses existing Card Networks to performs the authorization of the transaction amount for the cardholder's card account [105] the Issuing Bank. The Issuing Bank transmits the authorization response to the Acquiring Bank [107] through the Card Networks [106]. The Acquiring Bank next transmits the authorization response to the Processor [108], which then transmits the authorization response to the Payment Gateway [109]. The Payment Gateway holds the authorization response, and then transmits the transaction data to the Interchange Rate Based Convenience Fee, Service Fee, and Surcharge System [110]. The Interchange Rate Based Convenience Fee, Service Fee, and Surcharge System calculates the Interchange Fee using the authorization data and/or the BIN data from the card number, and also adds any Service Fees or Surcharges. The Interchange Rate Based Convenience Fee, Service Fee, and Surcharge System transmits these calculated data to the Payment Gateway [111], which submits the payment data to the Electronic Payment User Interface [112]. The Cardholder reads the display of the Electronic Payment User Interface which includes the payment amount and the associated Interchange Fee, Service Fee, and Surcharges (or some summation of these fees, the Convenience Fee) [113]. The cardholder can then complete the payment transaction.

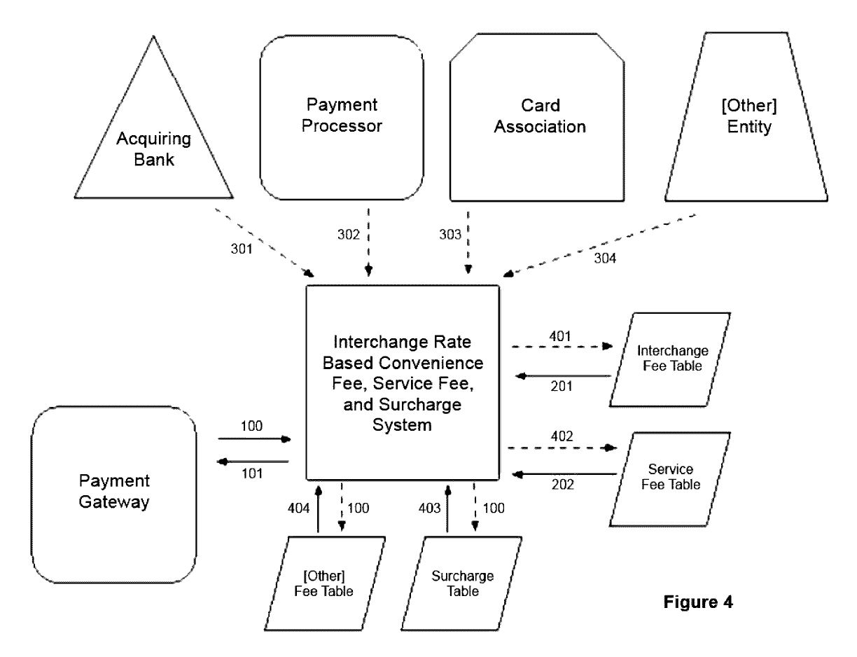

As illustrated in FIG. 4, the Payment Gateway transmits card data and/or authorization data, and/or other transaction data to the Interchange Rate Based Convenience Fee, Service Fee, and Surcharge System [100]. Fee data specific to that input transaction is output to the Payment Gateway once the specific fees have been calculated by the Interchange Rate Based Convenience Fee, Service Fee, and Surcharge System [102]. The Interchange Rate Based Convenience Fee, Service Fee, and Surcharge System reads the form the Payment Gateway data and calculates a specific Interchange Fee based on the data from the Payment Gateway and the stored data in the Interchange Fee Table [201]. Calculations for any Service Fee [202], Surcharge [203], or Other fees [204] that apply to that transaction are made by the Interchange Rate Based Convenience Fee, Service Fee, and Surcharge System. External to the Interchange Rate Based Convenience Fee, Service Fee, and Surcharge System are the Fee Creation Entities, including the Acquiring Bank, the Payment Processor, the Card Associations, and any other entities that create fees for electronic payment transactions. These Entities publish their fees in tables (machine or human-readable) or through agreements with Merchants or Payment Gateways. The Interchange Rate Based Convenience Fee, Service Fee, and Surcharge System receives the fee amount from the Fee Creation Entities through a machine-based transmittal or manual human input [301] [302] [303] [304]. The Interchange Rate Based Convenience Fee, Service Fee, and Surcharge System maintains databases, tables, or other computer-based storage schemes to store the fee data. The Interchange Rate Based Convenience Fee, Service Fee, and Surcharge System is operable to add, modify, and delete the fee tables whenever new fee data is input from the Fee Creation Entities.

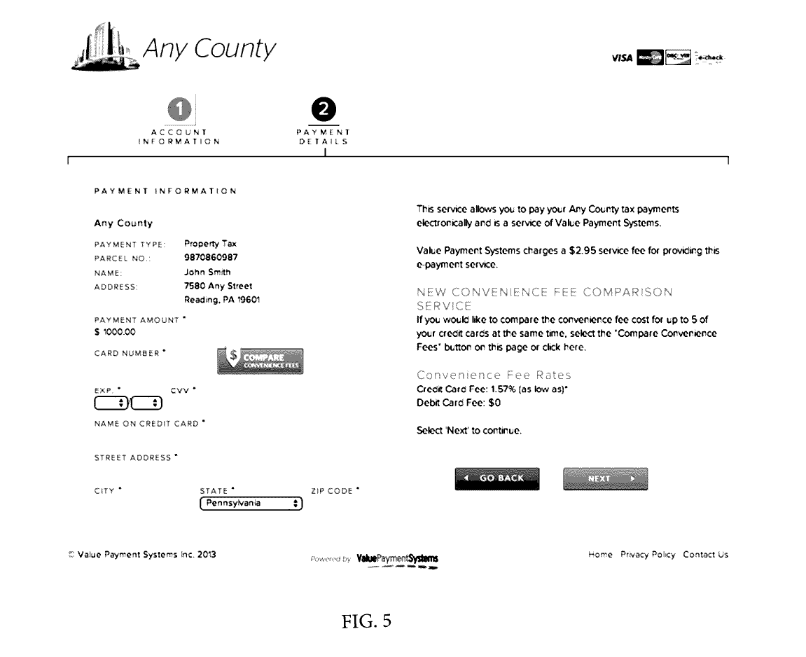

FIG. 5 is a screenshot of one embodiment of a GUI including a service description.

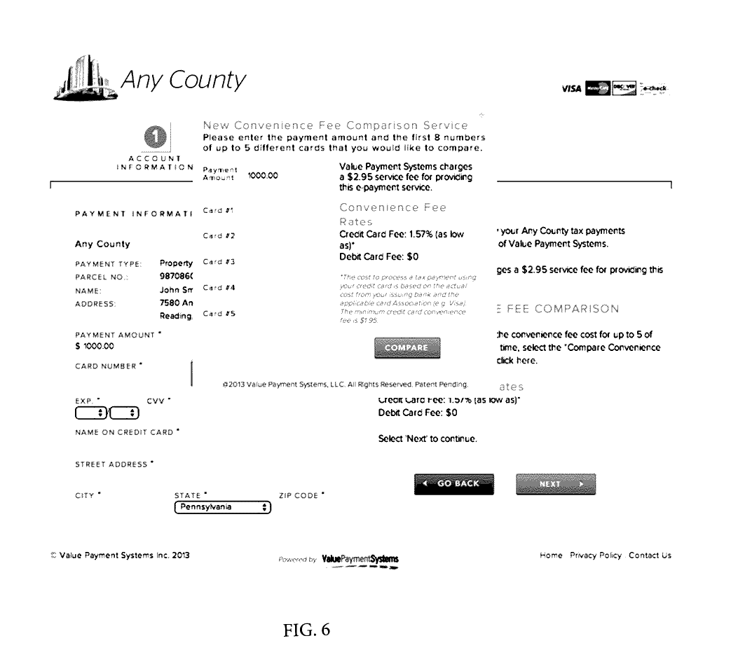

FIG. 6 is a screenshot of one embodiment of a GUI including a comparison tool.

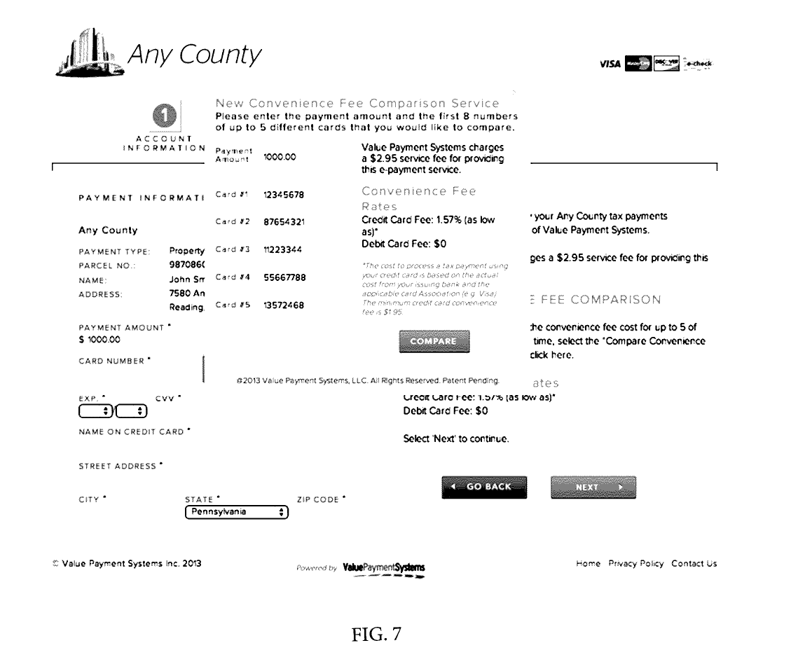

FIG. 7 is a screenshot of one embodiment of a GUI including a comparison tool with card entry.

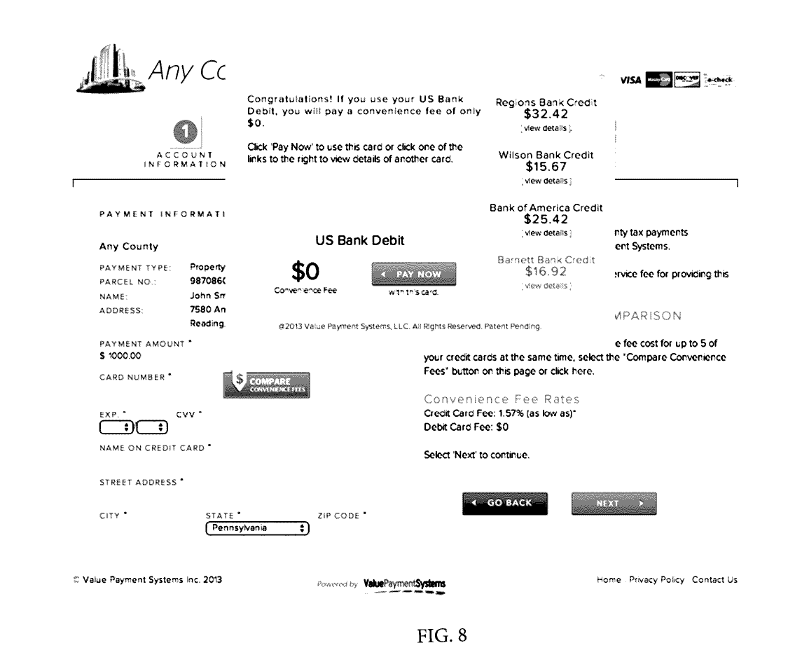

FIG. 8 is a screenshot of one embodiment of a GUI including results from interchange look-up.

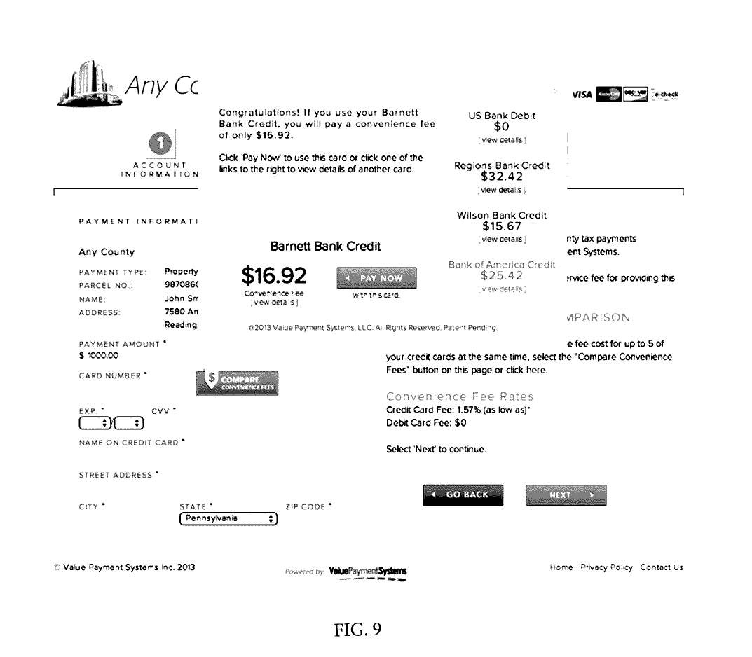

FIG. 9 is a screenshot of one embodiment of a GUI including a result of consumer driven options/savings.

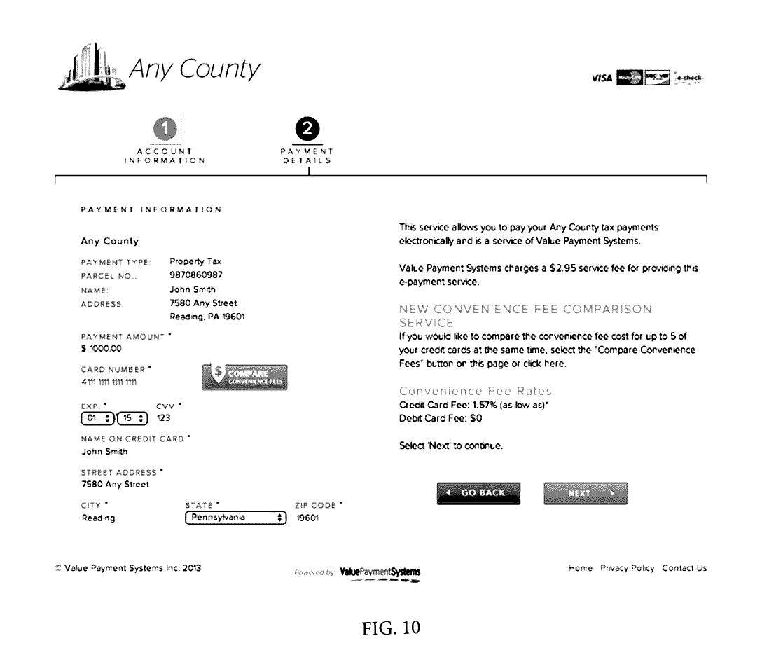

FIG. 10 is a screenshot of one embodiment of a GUI including expedited card information entry.

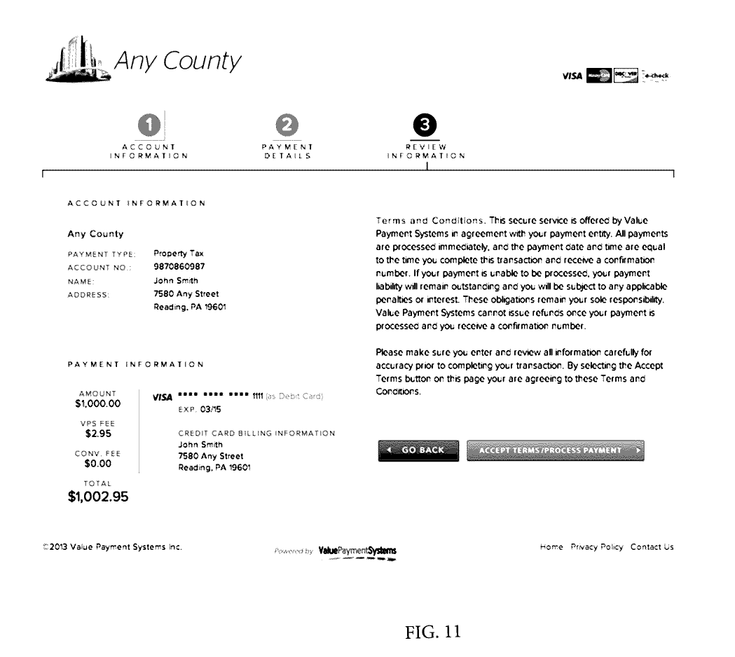

FIG. 11 is a screenshot of one embodiment of a GUI including a summary of account information, payment information, and terms and conditions.

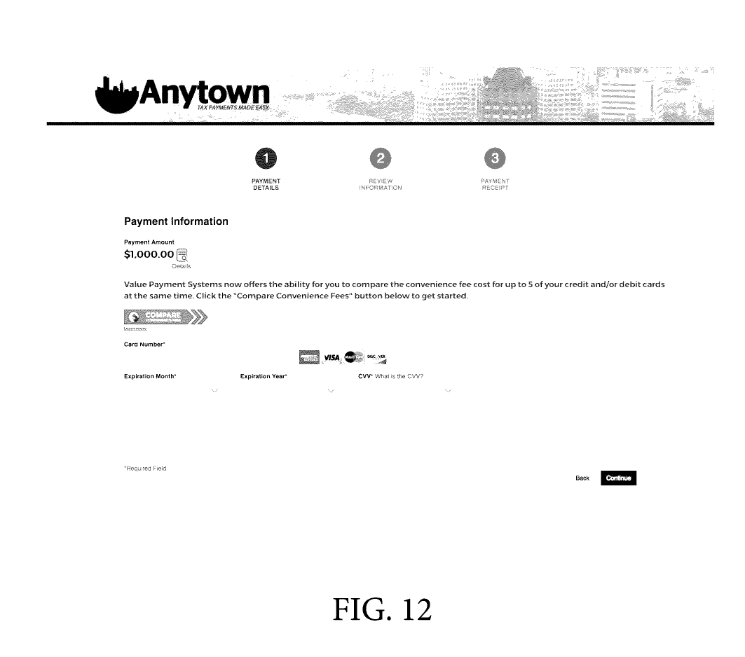

FIG. 12 is a screenshot of one embodiment of a GUI including a Convenience Fee Comparison Service. Upon pressing a Compare Convenience Fees button, a user enters information for up to 5 debit and/or credit cards to compare convenience fees for those cards for a particular transaction.

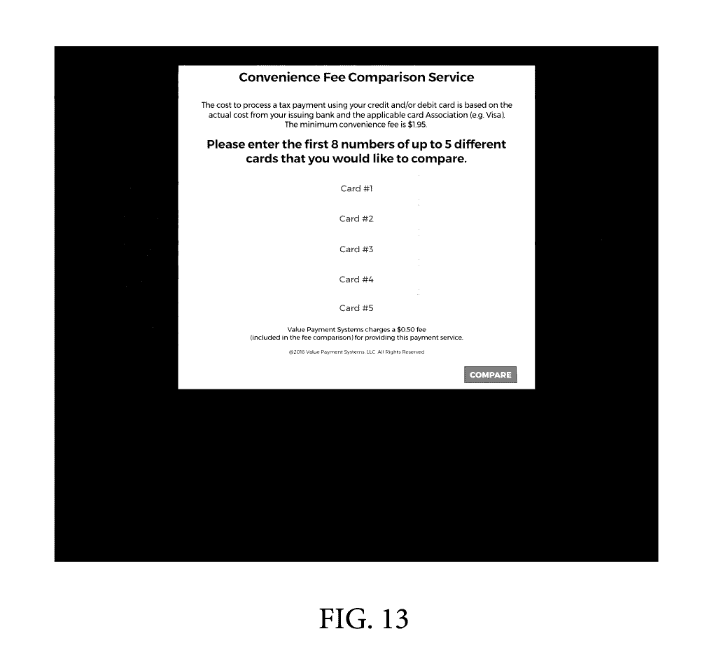

FIG. 13 is a screenshot of one embodiment of a GUI including a Convenience Fee Comparison Service. A Convenience Fee Comparison Service window overlays the existing GUI upon activation of the Compare Convenience Fees button. Alternatively, the Convenience Fee Comparison Service window is a new window opened in the GUI upon activation of the Compare Convenience Fees button. Entry of only the first 6 numbers of each card or the first 8 numbers of each card in one of the input boxes is necessary to determine the convenience fee associated with each card for a particular transaction.

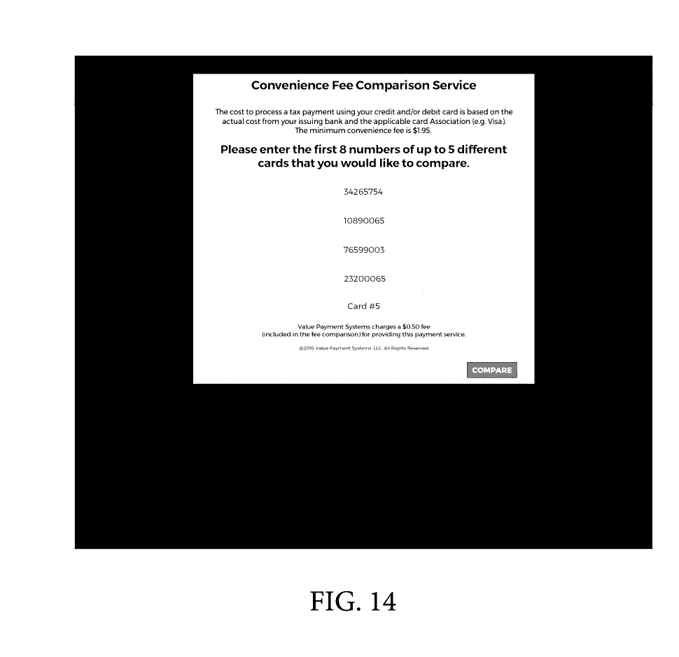

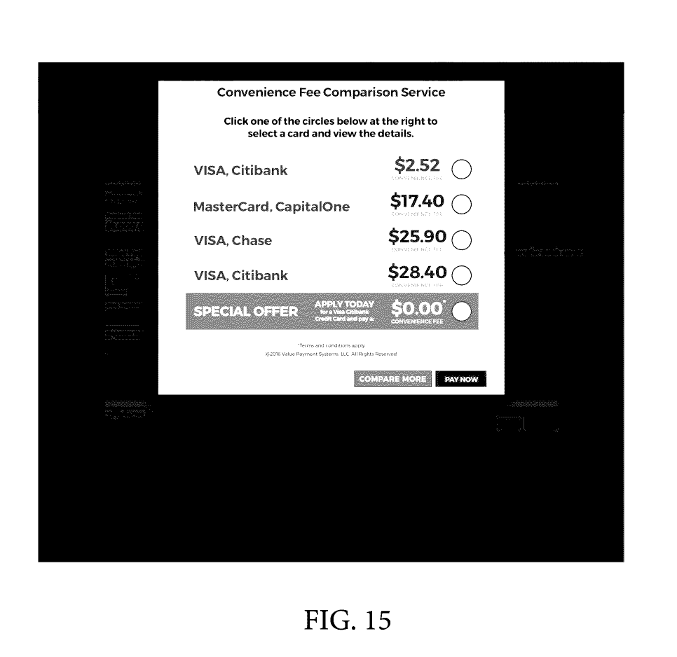

FIG. 14 is a screenshot of one embodiment of a GUI including a Convenience Fee Comparison Service. The first eight digits of 4 cards are entered in the boxes in this screenshot. Upon activation of the Compare button, the convenience fees are compared for the 4 cards. An example of a screenshot of a comparison of the convenience fees for the 4 cards is shown in FIG. 15.

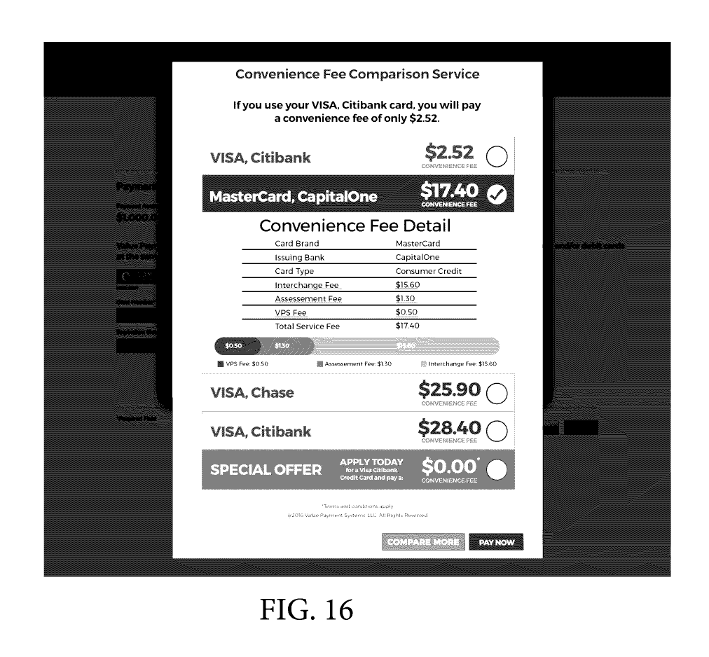

FIG. 15 is a screenshot of one embodiment of a GUI including a Convenience Fee Comparison Service. FIG. 15 displays the convenience fees associated with the first eight digits of each credit or debit card provided by the user. A radio button is included next to each credit or debit card. Additionally, a radio button is displayed next to a Special Offer, which upon selection of the radio button and selection of the Pay Now button, links the user to an application for a sponsored card. Alternatively, check boxes or drop down menus are utilized for selection and linking to an application for a sponsored card. FIG. 15 includes a Compare More button which provides additional boxes for the user to provide additional card numbers or partial card numbers, with the partial card numbers including but not limited to the first 6 digits of the card number or the first 8 digits of the card number. Upon selection of a radio button next to a desired card, details of the convenience fee are provided below the radio button, with one embodiment illustrated in FIG. 16.

FIG. 16 is a screenshot of one embodiment of a GUI including a Convenience Fee Comparison Service in which one of the radio buttons is selected and details of the convenience fee are provided for MasterCard, CapitalOne. Details of the convenience fee are provided immediately below the relevant card in the same window without redirecting to a new web page. Alternatively, selection of one of the radio buttons redirects the GUI to a new web page which displays details of the convenience fee. A card brand, an issuing bank, a card type, an interchange fee, assessment fee, VPS fee, and a total service fee are provided in FIG. 16. The Pay Now button is selected by the user to move to the payment screen.

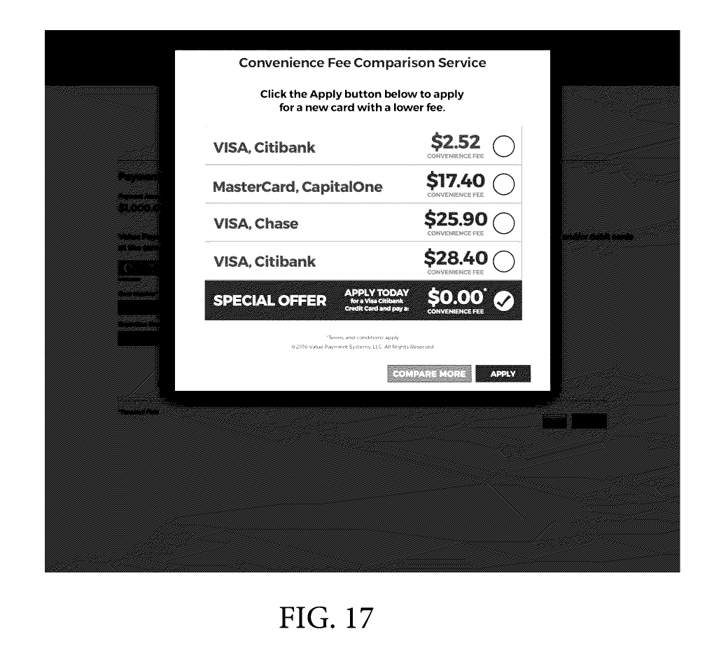

FIG. 17 is a screenshot of one embodiment of a GUI including a Convenience Fee Comparison Service including selection of a radio button next to the Special Offer. Upon selection of the radio button next to the Special Offer, the Pay Now button is transformed into an Apply button. The Apply button links to a web page or a pop-up window where the user can apply for the Special Offer and be approved for the Special Offer. Upon being approved for the Special Offer, the total transaction amount is operable to be paid using the new account associated with the Special Offer. In preferred embodiments, the new account associated with the Special Offer includes a credit card account, a debit card account, an online banking account, a gift card account, an online currency or digital currency account such as Bitcoin, etc.

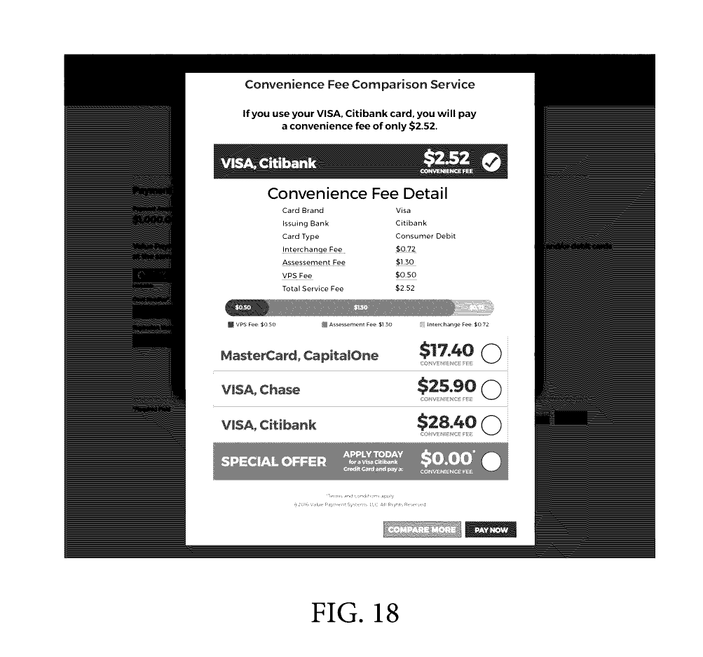

FIG. 18 is a screenshot of one embodiment of a GUI including a Convenience Fee Comparison Service in which one of the radio buttons is selected and details of the convenience fee are provided for VISA, Citibank. Details of the convenience fee are provided immediately below the relevant card in the same window without redirecting to a new web page. A card brand, an issuing bank, a card type, an interchange fee, assessment fee, VPS fee, and a total service fee are provided in FIG. 18. The Pay Now button is selected by the user to move to the payment screen.

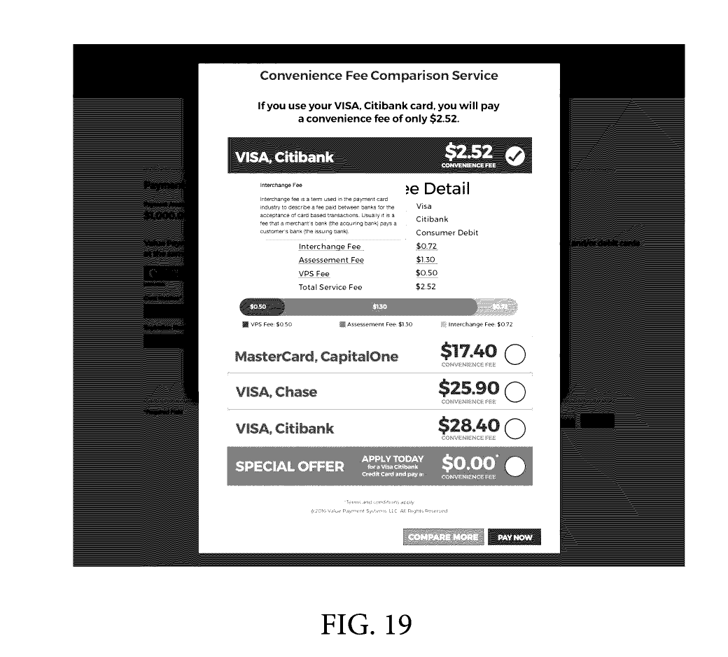

FIG. 19 is a screenshot of one embodiment of a GUI including a Convenience Fee Comparison Service including a pop-up with information about an interchange fee for VISA, Citibank. Upon hovering a mouse pointer or selection of the text “Interchange Fee,” information about the interchange fee appears, including the definition of interchange fee.

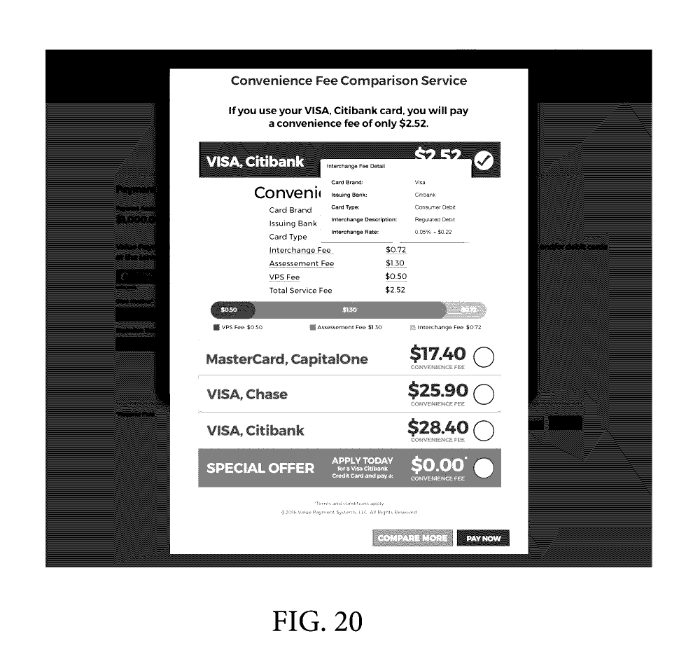

FIG. 20 is a screenshot of one embodiment of a GUI including a Convenience Fee Comparison Service including a pop-up with details about an interchange fee. Upon hovering a mouse pointer or selection of the amount of the interchange fee, the card brand, issuing bank, card type, interchange description, and interchange rate, with a formula for calculating the interchange rate, are provided.

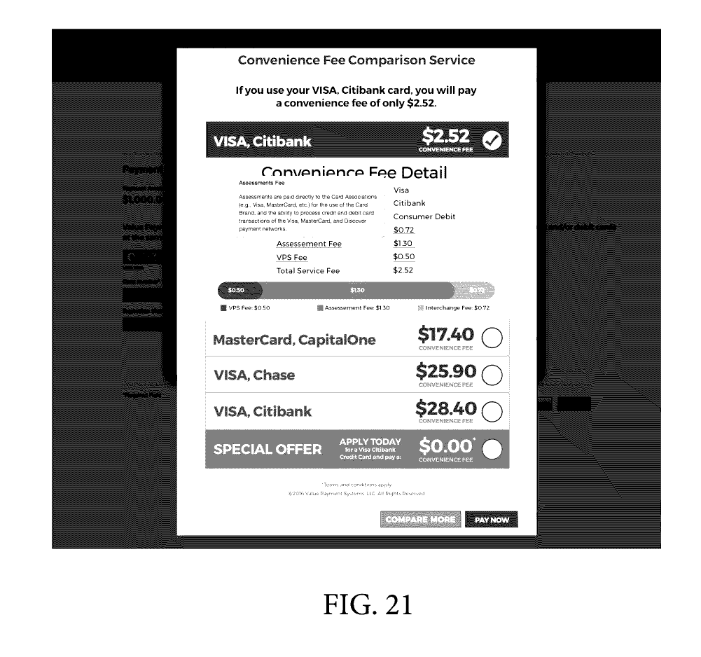

FIG. 21 is a screenshot of one embodiment of a GUI including a Convenience Fee Comparison Service including a pop-up with information about an Assessments Fee. Upon hovering a mouse pointer or selection of the text “Assessment Fee” via a keyboard command or touchscreen command, information about the assessment fee appears, including the definition of assessment fee.

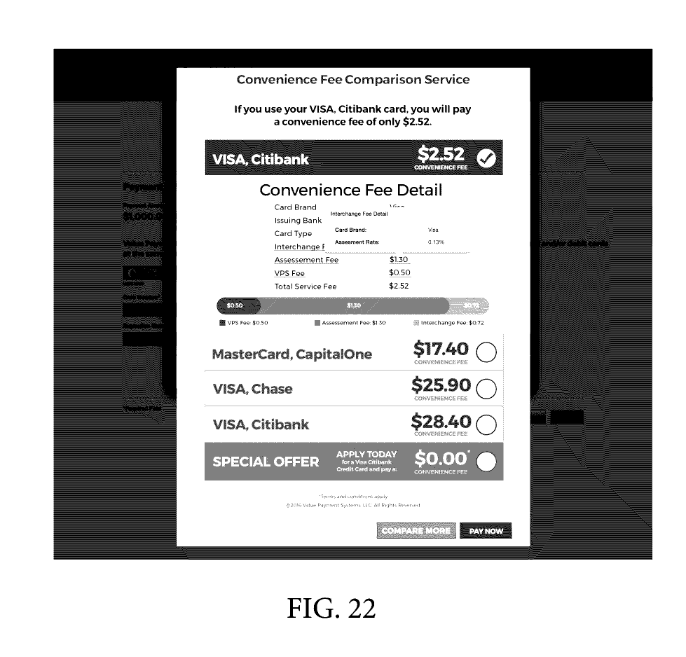

FIG. 22 is a screenshot of one embodiment of a GUI including a Convenience Fee Comparison Service including a pop-up with details about an Assessments Fee. Upon hovering a mouse pointer or selection of the amount of the assessment fee” via a keyboard command or touchscreen command, details about the assessment fee appears, including the card brand and the assessment rate.

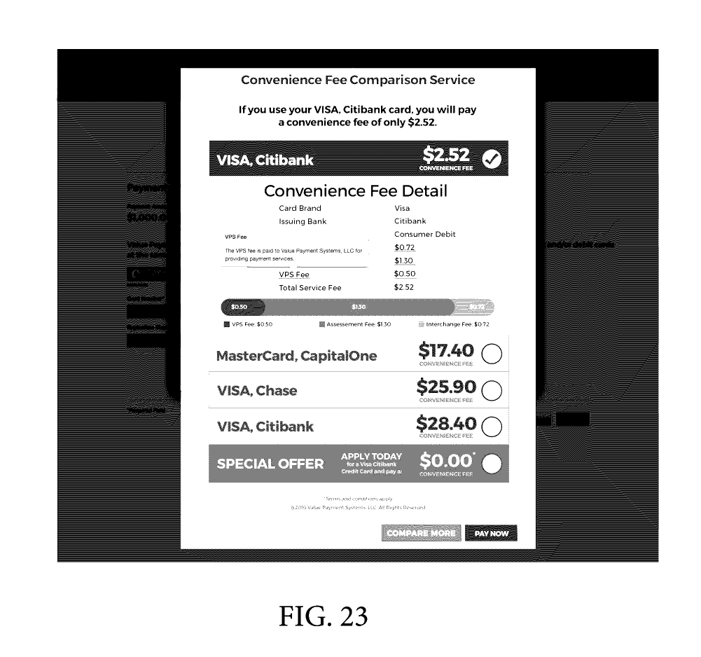

FIG. 23 is a screenshot of one embodiment of a GUI including a Convenience Fee Comparison Service including a pop-up with information about the VPS fee. Upon hovering a mouse pointer or selection of the VPS Fee via a keyboard command or touchscreen command, information about the VPS fee for providing payment services appears.

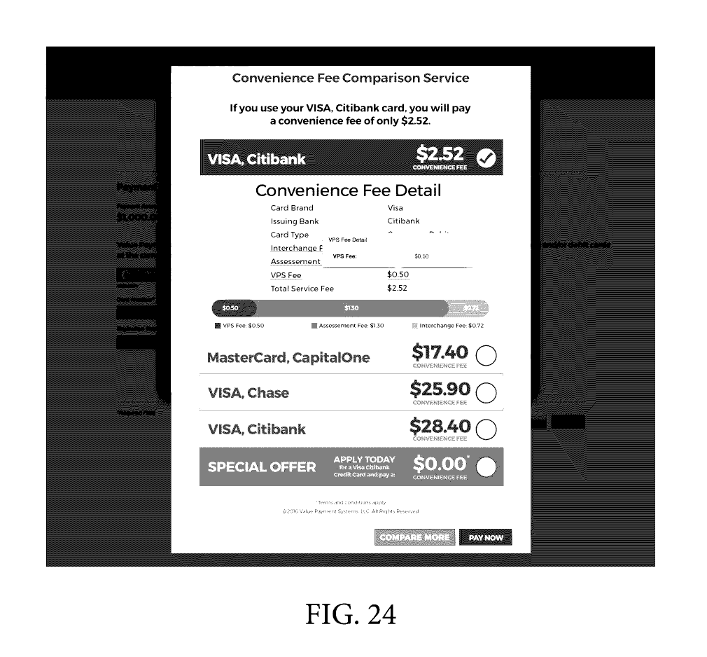

FIG. 24 is a screenshot of one embodiment of a GUI including a Convenience Fee Comparison Service including a pop-up with details about the VPS fee. Upon hovering a mouse pointer or selection of the VPS Fee via a keyboard command or touchscreen command, details about the VPS fee for providing payment services appears including the amount of the VPS fee.

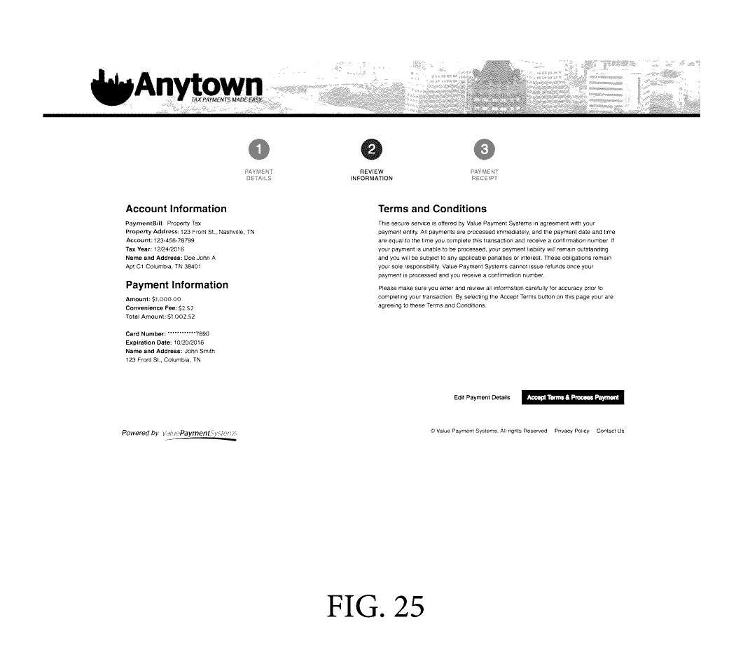

FIG. 25 is a screenshot of one embodiment of a GUI including a Payment Information section including information about the payment information selected. The Payment Information section includes the amount, the convenience fee, the total amount, the card number (partially encrypted), the expiration date, and the name and address of the card owner. Upon selection of the Accept Terms & Process Payment button, payment is submitted.

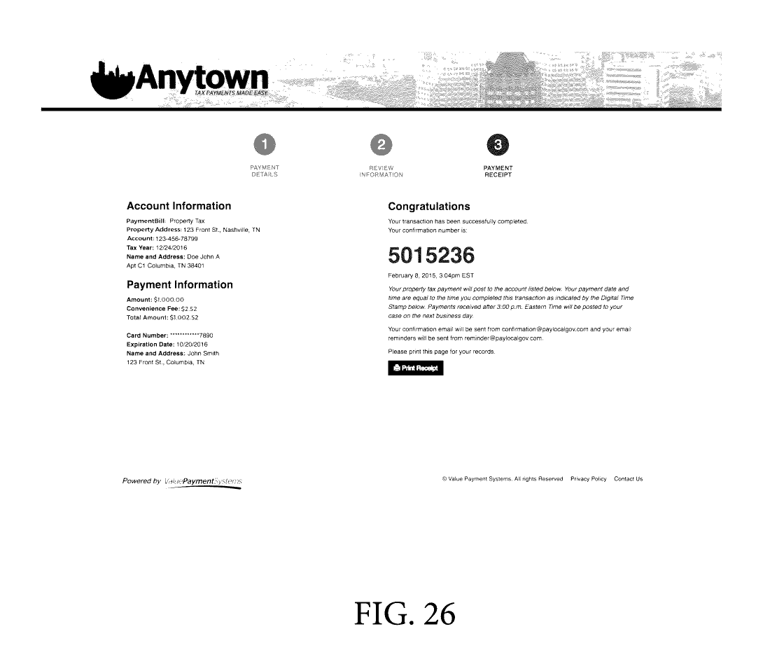

FIG. 26 is a screenshot of one embodiment of a GUI including a confirmation number and confirmation details. The confirmation details include the date at which the payment was submitted, details about confirmation email, and details about email reminders. The screenshot also includes a button which, when activated, provides for printing the receipt.

In one embodiment of the present invention, the message automatically generated to the cardholder user is transmitted by the system over the network and viewable as a graphic display of the information. Also, preferably, a table is provided indicating the itemized components of the convenience fee. In one embodiment, alternative card types are suggested where a lower fee is possible for the cardholder if a different card is used, i.e., a second card number is provided as an alternative to the first card number.

The present invention and preferred embodiments supporting best mode of application thereof as set forth in the foregoing, are supplied as examples and not intended to limit the scope of the invention thereto.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention as set forth in the claims.

The invention claimed is:

1. A method for retrieving electronic data over a network in real-time and displaying the electronic data in a graphical user interface (GUI) comprising the steps of:
providing an external network and an Interchange Rate Based Convenience Fee, Service Fee, and Surcharge System in external network communication with Fee Creation Entities, wherein the Interchange Rate Based Convenience Fee, Service Fee, and Surcharge System maintains a profile database including fee tables and/or other computer-based storage schemes for fee data storage, and wherein the Interchange Rate Based Convenience Fee, Service Fee, and Surcharge System is operable to add, modify and delete fee tables whenever new fee data is received from the Fee Creation Entities over the external network;
initiating a transaction by a cardholder via an Electronic Payment User Interface on the GUI;
receiving electronic transaction information corresponding to an account of the cardholder and an original payment amount for the cardholder;
automatically making a real-time lookup in the profile database for a real-time interchange rate associated with the account of the cardholder;
automatically determining a convenience fee by combining the real-time interchange rate with other fees, wherein the convenience fee is dynamically determined; and
calculating a total transaction amount for the cardholder, wherein the total transaction amount includes the original payment amount plus the convenience fee for the cardholder, wherein the total transaction amount payable by the cardholder is greater than the original payment amount or equal to the original payment amount.

2. The method of claim 1, wherein the real-time lookup is a real-time bank identification number (BIN) lookup, wherein attributes of the received electronic transaction information are detected including issuing bank, credit or debit card type, business or individual card, wherein a real-time interchange rate is determined based on the detected attributes.

3. The method of claim 1, wherein the steps are repeated until a step of receiving an approval input from the cardholder to process the transaction.

4. The method of claim 1, wherein the profile database includes a logical table including a plurality of logical rows and a plurality of logical columns to look up, store, and present real-time data, wherein each logical column corresponds to a convenience fee or components of a convenience free, wherein each logical row is associated with a separate account, wherein automatically making the real-time lookup in the profile database for the real-time interchange rate associated with the account of the cardholder includes looking up the real-time interchange rate using the plurality of logical rows and the plurality of logical columns.

5. The method of claim 1, further comprising presenting the convenience fee to the cardholder with a transparent indication of itemized components of the convenience fee, wherein the step of presenting a transparent indication includes a visual representation of a comparison between the itemized components included in the convenience fee and those of a multiplicity of alternative card types and/or issuing banks with lower convenience fees.

6. The method of claim 1, wherein the other fees include fees from the fee creation entities, wherein the fee creation entities include an acquiring bank, a payment processor, and a card association.

7. The method of claim 1, wherein the itemized components include at least one of the following fees: real-time interchange fee, dues and assessments, service provider fee(s), and combinations thereof.

8. The method of claim 5, further including the step of providing alternative credit card or debit card types that have a corresponding lower convenience fee, wherein the alternative credit or debit card types include a new cardholder account, wherein the corresponding lower convenience fee is a lower convenience fee on the transaction for the new cardholder account, further comprising the step of issuing the cardholder the new cardholder account for use in the transaction.

9. A method for retrieving electronic data over a network in real-time and displaying the electronic data in a graphical user interface (GUI) comprising the steps of:
providing an Interchange Rate Based Convenience Fee, Service Fee, and Surcharge System in external network communication with Fee Creation Entities, wherein the Interchange Rate Based Convenience Fee, Service Fee, and Surcharge System maintains databases, fee tables, and other computer-based storage schemes for fee data storage, and wherein the Interchange Rate Based Convenience Fee, Service Fee, and Surcharge System is operable to add, modify and delete fee tables whenever new fee data is received from the Fee Creation Entities;
initiating a transaction by a user via an Electronic Payment User Interface on a GUI;
receiving electronic payment information or data corresponding to at least two accounts of the user via at least two input boxes, wherein the electronic payment information or data includes eight numbers of each of the at least two accounts;
receiving an original transaction amount for the user;
automatically determining a real-time interchange rate associated with each of the at least two accounts of the user;
automatically transforming the real-time interchange rate, and at least a merchant service fee into a convenience fee for each of the at least two accounts;
presenting the convenience fee for each of the at least two accounts to the user;
wherein presenting the convenience fee to the user includes a real-time interchange fee, an assessment fee, and service provider fee(s); and
upon selection of one of the at least two accounts and activation of a pay now button, calculating a total transaction amount for the user, the total transaction amount including the original transaction amount plus the convenience fee to the user, wherein the total transaction amount payable by the user is greater than the original transaction amount or equal to the original payment amount.

10. The method of claim 9, wherein presenting the real-time interchange fee includes presenting an interchange rate via a pop-up window upon the user selecting the real-time interchange fee via hovering action via a cursor or via a keyboard command, wherein the interchange rate includes a number indicating the percentage of the original transaction amount and/or a flat rate.

11. The method of claim 9, further comprising presenting the convenience fee to the cardholder with a transparent indication of itemized components of the convenience fee, wherein the step of presenting the transparent indication includes a visual representation on the GUI of a comparison between the itemized fees included in the convenience fee and a multiplicity of convenience fees associated with a multiplicity of alternative accounts.

12. The method of claim 11, further including step of issuing an alternative account selected from the multiplicity of alternative accounts.

13. The method of claim 9, wherein automatically determining the real-time interchange rate associated with each of the at least two accounts of the user includes, via a data storage and retrieval system for a computer memory, retrieving the real-time interchange rate in real-time from a logical table which is updated in real-time, wherein the logical table includes a plurality of logical rows, each said logical row corresponding to a record of information, a plurality of logical columns intersecting said plurality of logical rows to define a plurality of logical cells, and means for indexing data stored in said table.

14. The method of claim 9, further including the step of providing alternative accounts including a card brand, an issuing bank, a convenience fee, and a selectable button, wherein the alternative accounts include a new account having a corresponding lower convenience fee, further comprising:
issuing the new account for use in the transaction by selecting the button associated with the new account, wherein selecting the button associated with the new account causes the pay now button to transform into an apply button;
selecting the apply button to apply for the new account; and
upon issuance of the new account, paying the total transaction amount using the new account.

15. A method for retrieving electronic data over a network in real-time and displaying the electronic data in a graphical user interface (GUI) comprising the steps of:
providing an Interchange Rate Based Convenience Fee, Service Fee, and Surcharge System in external network communication with Fee Creation Entities, wherein the Interchange Rate Based Convenience Fee, Service Fee, and Surcharge System maintains databases, fee tables, and other computer-based storage schemes for fee data storage, and wherein the Interchange Rate Based Convenience Fee, Service Fee, and Surcharge System is operable to add, modify and delete fee tables whenever new fee data is received from the Fee Creation Entities;
initiating a transaction by a cardholder;
receiving electronic transaction information corresponding to an account of and an original transaction amount for the cardholder;
receiving electronic payment information or data corresponding to multiple cardholder accounts, wherein the multiple cardholder accounts include the account of the cardholder;
automatically making a real-time bank identification number (BIN) lookup for determining a real-time interchange rate associated with each of the multiple cardholder accounts;
automatically transforming each of the real-time interchange rates and at least one fee into convenience fees;
presenting each of the convenience fees to the cardholder; and
calculating a total transaction amount for the cardholder, the total transaction amount including the original transaction amount plus at least one of the convenience fees for the cardholder and the card presented, wherein the total transaction amount payable by the cardholder is greater than the original transaction amount or equal to the original payment amount.

16. The method of claim 15, further including the step of transmitting the electronic transaction information to a processor for processing.

17. The method of claim 15, wherein the steps are repeated until a step of receiving an approval input from the cardholder to process the transaction.

18. The method of claim 15, further including the step of issuing a credit or debit card of the alternative credit or debit card type.

19. The method of claim 15, further including presenting a transparent indication of itemized factors included in each of the convenience fees to the cardholder by presenting a visual representation of a comparison between the itemized factors included in the convenience fee for the card presented and those of a multiplicity of alternative card types and/or issuing banks where lower convenience fees are applicable.

20. The method of claim 19, wherein the itemized factors include at least one of the following fees: real-time interchange fee, dues and assessments, service provider fee(s), and combinations thereof.
